(19) United States
(12) Patent Application Publication
(10) Pub. No.: US 2016/0188646 A1
(43) Pub. Date: Jun. 30, 2016

(54) EFFICIENT DATABASE SCREENING AND COMPRESSION

(71) Applicant: Cytegeic, Tel Aviv (IL)

(72) Inventors: Shay Zandani, Rehovot (IL); Elon Kaplan, Ramat Hasharon (IL)

(73) Assignee: Cytegeic, Tel Aviv (IL)

(21) Appl. No.: 14/980,333

(22) Filed: Dec. 28, 2015

Related U.S. Application Data
(60) Provisional application No. 62/096,914, filed on Dec. 26, 2014.

(51) Int. Cl. G06F 17/30

(52) U.S. Cl. CPC G06F 17/30327; G06F 17/30595; G06F 17/30569; G06F 17/30365

(57) ABSTRACT

There is provided, in accordance with an embodiment, a method comprising using one or more hardware processor for receiving two or more electronic documents from two or more computerized sources, where each of the electronic documents comprise alphanumeric text. A hierarchical mapping database is retreived, where the hierarchical mapping database comprises records that map between two or more map terms, each comprising two or more words, phrases, and codes, and between a tree structure of unique codes, where the tree structure comprises unique codes for each of at least four classes, and where each of the map terms is mapped to one of the unique codes. The electronic documents are screened to obtain a subset of electronic documents by locating a matching between some of the map terms in some of the classes. The subset is stored in a database on a non-transitory storage medium.

### CROSS REFERENCE TO RELATED APPLICATIONS

This application claims the benefit of an earlier filing date from U.S. Provisional Patent Application No. 62/096,914, filed Dec. 26, 2014, entitled “CYBER TRENDS ANALYSIS”, incorporated herein by reference in its entirety.

### FIELD OF THE INVENTION

The invention relates to the field of large databases.

### BACKGROUND

Many computerized applications may be process large amounts of data. For example, large amounts of data may relate to searching for a missing person by a police force, such as described in BLACKMORE et al., “Data Mining of Missing Persons Data”, Classification and Clustering for Knowledge Discovery, 22 Aug. 2005, Volume 4 of the series Studies in Computational Intelligence, pages 305-314. For example, huge amounts of data may relate to medical conditions and used in epidemiological studies relating survival risk factors, such as described in PAL et al., “Data mining approach for coronary artery disease screening”, Proceedings of the International Conference on Image Information Processing (ICIIP), 3-5 Nov. 2011, pages 1-6, Print ISBN: 978-1-61284-859-4. For example, large databases may be analyzed for predicting machine failure and directing preventive maintenance, as described in BASTOS et al., “Maintenance behaviour-based prediction system using data mining”, Proceedings of the World Congress on Engineering 2012 Vol III, Jul. 4-6, 2012, pages 1448-1453, ISBN: 978-988-19252-2-0, Print ISSN: 2078-0958, Online ISSN: 2078-0966.

For example, overwhelming amounts of data may be used in computerized resource demand anticipation, such as described in CHANG et al., “Data Analytics for Optimising Cyber and Data Centre Operation”, Singapore Government, Defence Science and Technology Agency—Horizons 2015, Issue 10, pages 54-59, Print ISSN 2339-529X, Online ISSN 2339-5303. For example, security data may relate to attacks that occurred in various geographies, on variety of assets, in a variety of industries, conducted by a variety of attackers and aiming to achieve one or more objectives. In some example, input data analyzed for the example applications may cumulate to billions of electronic documents to analyze per day. Human capacity limitations make the digesting of such a vast amount of data impractical, not to mention impractical to draw meaningful conclusions from it.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method comprising using one or more hardware processor for receiving two or more electronic documents from two or more computerized sources, where each of the electronic documents comprise alphanumeric text. The hardware processor(s) are used for retrieving, from a non-transitory storage medium, a hierarchical mapping database, where the hierarchical mapping database comprises records that map between two or more map terms, each comprising two or more words, phrases, and codes, and between a tree structure of unique codes, where the tree structure comprises unique codes for each of at least four classes, and where each of the map terms is mapped to one of the unique codes. The hardware processor(s) are used for screening the electronic documents to obtain a subset of the electronic documents by locating in the electronic documents a matching between some of the map terms in some of the classes. The hardware processor(s) are used for storing the subset in a database on the non-transitory storage medium.

Optionally, the method further comprises using the hardware processor(s) for analyzing each electronic document of the subset to produce two or more target records, where each target record comprises a record vector of at least four values of the unique codes. Each target record comprises a record hierarchy of the record vector values. The hardware processor(s) are used for storing the target records in a database on the non-transitory storage medium.

Optionally, the analyzing of each electronic document comprises locating all occurrences of the map terms in the electronic document, calculating a positional relationship between the occurrences in the electronic document, performing a sematic analysis of each of the occurrences to determine a sematic classification in the document and a sematic relationship between the occurrences, and generating one or more database record for each instance of a detection of two or more the occurrences in a positional relationship according to one of two or more criteria, producing two or more target records for the subset. Each the target record comprises one or more unique code for each of the classes, and where the at least four unique codes are selected to represent the unique codes closest to a leaf in the tree structure.

Optionally, the electronic documents are stored in a non-relational database.

Optionally, the subset is stored in a relational database.

Optionally, the screening performs a lossy compression of the electronic documents.

Optionally, each of the words, phrases, and codes are in one or more of two or more languages and two or more syntaxes.

There is provided, in accordance with an embodiment, a method comprising using one or more hardware processor for receiving two or more electronic documents stored on a non-relational NoSQL database, where each of the of electronic documents comprise alphanumeric text. The hardware processor(s) are used for retrieving, from a non-transitory storage medium, a hierarchical mapping database, where the hierarchical mapping database maps between two or more map terms, each comprising one of a word, a phrase, and a code in two or more languages and two or more syntaxes, and between a tree structure of unique codes, where the tree structure comprises unique codes for each of at least four classes, and where each of the map terms is mapped to one of the unique codes. The hardware processor(s) are used for screening the electronic documents to obtain a subset of the electronic documents by locating in the electronic documents a matching between some of the map terms in some of the classes. The hardware processor(s) are used for analyzing each screened electronic document in the subset by locating all occurrences of the map terms within the screened electronic document The hardware processor(s) are used for analyzing each screened electronic document in the subset by calculating a positional relationship between the occurrences within the screened electronic document. The hardware processor(s) are used for analyzing each screened electronic document in the subset by generating one or more database record for each instance of a detection of two or more the occurrences in a positional relationship according to one of two or more criteria, producing two or more target records for the subset. Each the database record comprises at least four of the unique codes, one or more unique code for each of the classes, and two or more hierarchal relationships, and where the at least four unique codes are selected to represent the unique codes closest to a leaf of the tree structure. The hardware processor(s) are used for storing the target records in a structured query language relational database located on the non-transitory storage medium.

There is provided, in accordance with an embodiment, a computerized system, comprising a non-transitory computer-readable storage medium having stored thereon program code for receiving two or more electronic documents from two or more computerized sources, where each of the electronic documents comprise alphanumeric text. The program code is for retrieving a hierarchical mapping database, where the hierarchical mapping database comprises records that map between two or more map terms, each comprising two or more words, phrases, and codes, and between a tree structure of unique codes, where the tree structure comprises unique codes for each of at least four classes, and where each of the map terms is mapped to one of the unique codes. The program code is for screening the electronic documents to obtain a subset of the electronic documents by locating in the electronic documents a matching between some of the map terms in some of the classes. The program code is for storing the subset in a database. The computerized system comprises one or more hardware processor configured to execute the program code.

Optionally, the computerized system further comprises analyzing each electronic document of the subset to produce two or more target records. Each target record comprises a record vector of at least four values of the unique codes. Each target record comprises a record hierarchy of the record vector values. The computerized system further comprises storing the target records in a database.

Optionally, the electronic documents are stored in a non-relational database.

Optionally, the subset is stored in a relational database.

Optionally, the screening performs a lossy compression of the electronic documents.

Optionally, each of the words, phrases, and codes are in one or more of two or more languages and two or more syntaxes.

There is provided, in accordance with an embodiment, a computer program product comprising a non-transitory computer-readable storage medium having program code embodied therewith. The program code instructs hardware processor(s) to receive two or more electronic documents from two or more computerized sources, where each of the electronic documents comprise alphanumeric text. The program code instructs hardware processor(s) to retrieve a hierarchical mapping database, where the hierarchical mapping database comprises records that map between two or more map terms, each comprising two or more words, phrases, and codes, and between a tree structure of unique codes, where the tree structure comprises unique codes for each of at least four classes, and where each of the map terms is mapped to one of the unique codes. The program code instructs hardware processor(s) to screen the electronic documents to obtain a subset of the electronic documents by locating in the electronic documents a matching between some of the map terms in some of the classes. The program code instructs hardware processor(s) to stores the subset in a database.

Optionally, the program code further comprises processor instruction for analyzing each electronic document of the subset to produce two or more target records. Each target record comprises a record vector of at least four values of the unique codes. Each target record comprises a record hierarchy of the record vector values. The program code comprises processor instruction for storing the target records in a database.

Optionally, the electronic documents are stored in a non-relational database.

Optionally, the subset is stored in a relational database.

Optionally, the screening performs a lossy compression of the electronic documents.

Optionally, each of the words, phrases, and codes are in one or more of two or more languages and two or more syntaxes.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a schematic illustration of a system for large database screening, according to some embodiments of the present invention;

FIG. 2 shows a flowchart of a method for large database screening, according to some embodiments of the present invention;

FIG. 3 shows a flowchart of a method for large database analysis after database screening, according to some embodiments of the present invention;

FIG. 4 shows a flowchart of a method for trend analysis, pattern analysis, and forecasting, according to some embodiments of the present invention;

FIG. 5 shows a flowchart of a method for correcting a forecast with user input, according to some embodiments of the present invention;

FIG. 6 shows a screenshot of a user interface showing a list of sources of electronic documents for database screening, according to some embodiments of the present invention;

FIG. 7 shows a screenshot of a user interface showing a search result of the mapped entries “Anonymos” or “Anonymus” in a hierarchical mapping database, according to some embodiments of the present invention;

FIG. 8 shows a screenshot of a user interface showing a subset list of electronic documents in a database after screening, according to some embodiments of the present invention;

FIG. 9 shows a screenshot of an electronic document in the Spanish language and the resulting event record in a database, according to some embodiments of the present invention;

FIG. 10 shows a screenshot of an electronic document in the Arabic language and the resulting event record in a database, according to some embodiments of the present invention;

FIG. 11 shows a screenshot of an electronic document in the English language and the resulting event record in a database, according to some embodiments of the present invention;

FIG. 12 shows a screenshot of an electronic document in the Farsi language and the resulting event record in a database, according to some embodiments of the present invention; and

FIG. 13 shows a screenshot of analysis results of event records in a database displayed on a calendar, according to some embodiments of the present invention.

### DETAILED DESCRIPTION

According to some embodiments of the present invention, there are provided systems, computer program products, and methods for using a hierarchical mapping database to automatically screen a large amount of data, such as in electronic documents, prior to a detailed analysis of positional and sematic relationships between targeted terms, phrases, and codes present in the text of the electronic documents.

The hierarchical mapping database (HMD) may be manually created by a human operator prior to the implementation of aspects of the embodiments, and reflects the different words that can be synonyms for a target map entry. For example, the word for cancer in different languages, different contexts, and/or the like. For example, a medical report may refer to a type of cancer as a malignant tumor, an astrocytoma, a glioblastoma, and/or the like, and on the other hand a twitter feed may use the term brain cancer, liver cancer, a growth in the liver, and/or the like. The HMD comprises map entries and each map entry comprises a unique code for that entry and a list of terms that are synonymous with that entry. The HMD lists both the hierarchical arrangement of the unique codes, such as a tree structure and the like, as well as synonyms for each map entry in the electronic documents, such as the same terms in different languages and the like. For example, the terms are translated to English, Arabic, Spanish, Turkish, Farsi, Portuguese, Mandarin Chinese, Russian, and/or the like.

According to some embodiments of the present invention, the automatic screening allows a large amount of data stored in a non-relational NoSQL database to be suitable for storage in a structured query language (SQL) database. For example, embodiments of the invention allow lossy compression of large databases analogous to lossy compression of digital images using the Joint Photographic Experts Group (JPG) method. By selecting a high level of screening for the large database it may be stored in a fraction of the space and thus suitable for storage on databases that cannot handle large amounts of data efficiently, such as SQL databases. The screening terms may ensure that the important information needed for analysis of the large amount of data may be retained in the screened data subset, and thus the important conclusions of the analysis are not changed as a result of discarding some of the original data. Analogously, the image of a highly compressed JPG image contains identifiable objects despite losing most of the image data.

The screening of a large number of electronic documents to produce a subset of relevant electronic documents may reduce the size of the database containing the electronic documents by orders of magnitude. For example, on Jul. 30, 2014, a large number of electronic documents were received from multiple sources, such as tweeter, facebook, intelligence feeds, and/or the like, and stored in a NoSQL database, such as a MongoDB® database, with a size of 51.4 gigabytes. After screening using multiple terms associated with Anonymous (attacker) and Trojan (attack method), a subset of the electronic documents was stored in a SQL database, such as an Oracle® MySQL® database, with a size of 15.7 megabytes, resulting in a 1:3,274 compression ratio. In another example, on Aug. 3, 2014, 62.1 gigabytes were stored in a NoSQL database and screening reduced the database size to 13.4 megabytes, a compression ratio of 1:4,634. In another example, on Aug. 3, 2014, 41.2 gigabytes were stored in a NoSQL database and screening reduced the database size to 19.8 megabytes, a compression ratio of 1:2,081. Optionally, the compression ratios can be in the range of 1:500 to 1:50,000, depending on the amount of total electronic document sizes received from the sources, such as the amount of activity, the size of the documents, and/or the like, and the total amount of relevant document activity, such as the nearness of an upcoming significant date and the like. Optionally, the compression ratios can be in the range of 1:1,00 to 1:10,000. Optionally, the compression ratios can be in the range of 1:1,00 to 1:5,000.

As used herein, the word “term” refers to any single search element related to the subject matter, such as a word, a phrase, a code, a synonym, an antonym, and/or the like. For example, an International Classification of Diseases (ICD) code may represent a specific disease, and be related to a hierarchy of terms in the mapping database. For example, the term deceased may be related to the term survived in the mapping database, both as types of disease outcomes. As used herein, “map entry” refers to a set of multiple synonymous terms the represent a unique entity and/or element of interest according to the subject application. For example, a map entry comprises the term cancer in multiple languages.

According to aspects of some embodiments, the HMD is arranged in classes that represent major aspects of the terms. For example, in medical applications the classes may include type of disease, location of disease, outcome of subject, location of subject, and/or the like. For example, in security applications, the classes may include attacker (TA), attack method (AM), geopolitical region (GeoPol), industry, attacked asset, objective, timeframe, and/or the like. By prioritizing some of the classes and some of the map entries, a screening of the large amounts of data may be automatically performed prior to a full automatic analysis of the electronic documents. For example, automatic screening of relevant terms in the HMD may allow orders of magnitude in size reduction in the number of electronic documents. For example, the smaller the number of screened terms and classes the resulting screened subset of the large data will be smaller in size.

Optionally, the optimum number of screened terms and classes may depend on the size of the large data, the restrictions of the size of the subset, the objective of the analysis, the source of the electronic documents, features of each electronic document, and/or the like. For example, an electronic document is a security warning feed and may require only one term and one class. For example, an electronic document is from a tweeter feed and/or a social network uniform resource locator (URL), and may require two or more terms from two or more classes. The number of terms and/or classes may be determined by a weighting factor that is computed from a lookup table of parameters, one each assigned to the electronic document type, the source, the presence of other terms, and the like. For example, some terms may have high weighting parameters, such as important terms like bomb, attack, revenge, and/or the like, and indicate the electronic document has a high probability of containing significant information, such as essential information, vital information, and/or the like.

The automatic screening of the data may be performed at a central computer system, such as a server, a computer cluster, a computer farm, or in a distributed processing system. Once the screening has identified which electronic documents contain the screening terms, such as having a good probability of containing useful information, this subset of the electronic documents may be automatically analyzed with a full search for all terms and the relationships between the terms according to a location within the document, a relative location to other terms, and/or semantic analysis to produce target database records of useful information for further downstream statistical analysis, modeling, correlation, trend analysis, pattern analysis, and/or the like.

By selecting the classes and map entries used for screening, the entire data mining process can be optimized for hardware processor execution time to be performed on a single server or single cluster of servers in a reasonable amount of time. For example, in the case of security data screening, the screening classes may be attack entity and attack method, and some or all terms within each of these classes marked as being a term(s) used for screening the electronic documents.

Security data screening is used in this application by way of non-limiting example, but aspects of some embodiments may be applicable to most database screening and/or analysis.

As used herein, in security applications an asset is an object, technology or process that is the target of a security attack. For example, some types of assets are listed in TABLE 1.

TABLE 1

| Asset Type | Examples |
|---|---|
| client data | bank account data of a banking client, credit |
| | card information, and/or the like |
| communication | internet connection between a bank and a stock |
| infrastructure | exchange, satellite communications, and/or the like |
| manufacturing | supply chain, value chain, engineering quality |
| data | documents, and/or the like |
| services | automatic teller machine services, and/or the like |
| intellectual | drawings of assets, trade secrets, reputation, |
| property (IP) | and/or the like |
| operational | programmable logic controllers, electrical |
| infrastructure | networks, water networks, and/or the like |

As used herein, in security applications an attack method (AM) refers to the method of performing a security attack on an asset. For example, an attack method may be a resource depletion, an abuse of functionality, a social engineering modification, a code replacement, a phishing attack, and/or the like. For example, an attack method in the HMD may contain a 5-level hierarchy of: Threat=>Malware=>Trojan=>Remote Access Trojan=>Gh0st RAT.

The trends analysis and/or forecast methods provide an automatic analysis process which may convert an abundance of data into meaningful information for decision makers. For example, a trends analysis may allow a decision maker to allocate additional resources to increase anti-hacking security.

For example, according to aspects of some embodiments a method may include a first step of trends analysis and forecast, a second step of events trends analysis and a third step of synthesis of the forecast and the events trends analysis to receive a corrected forecast.

Aspects of some embodiments may be implemented as dedicated software on a computerized system. Such software may include instructions to a User Interface (UI), such as a Graphical User Interface (GUI), which may allow the user to interact with the software, including instructions to receive electronic documents, query the associated databases, store the security events, and provide a security forecast to a user.

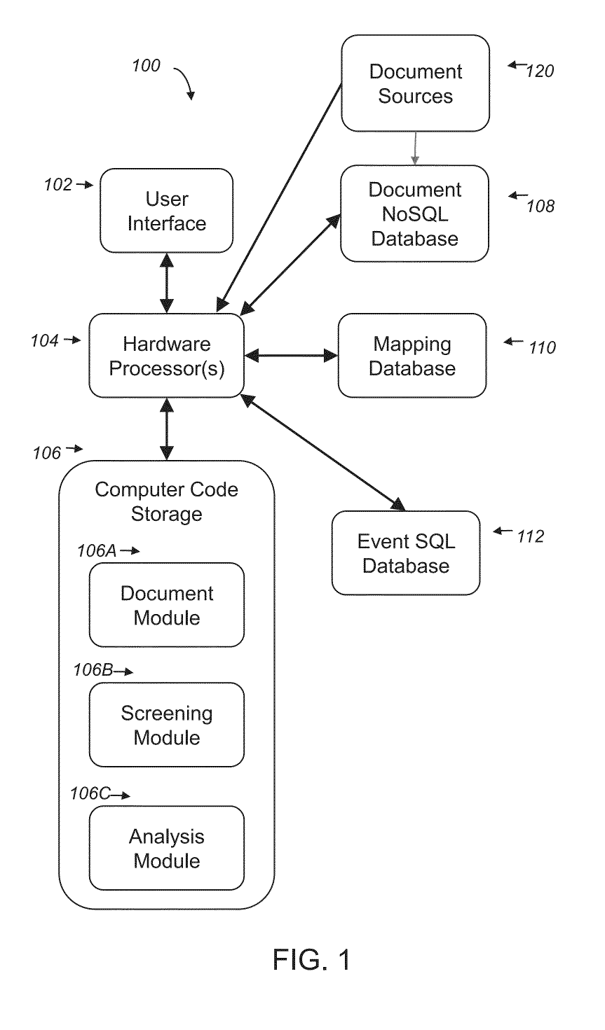

Reference is now made to FIG. 1, which is a schematic illustration of a system 100 for large database screening, according to some embodiments of the present invention. System comprises one or more hardware processors 104 for performing screening and/or analysis of electronic documents in a large database. Accessible by hardware processor(s) 104 is a computer code storage 106, that stores thereon computer code modules of processor instructions to be executed by the hardware processor(s) 104.

Hardware processor(s) 104 receive electronic documents from multiple document sources 120, an electronic document non-relational database 108, such as a NoSQL database, a combination thereof, and/or the like. For example, hardware processor(s) 104 receive electronic documents from multiple electronic feeds 120, such as a twitter feed, a Facebook feed, a Reuters feed, and/or the like, and store the documents on NoSQL database 108. A document module 106A comprises processor instruction to receive and store the electronic documents. Optionally, electronic document database 108, HMD 110, subset, the event record database 112, and/or any combination thereof are stored on different physical storage mediums, such as cloud storage. Optionally, the databases are stored on a single storage medium.

Hardware processor(s) 104 retrieve a mapping database 110 that maps terms of interest to unique codes and classes in a hierarchical structure, such as a tree structure. A user enters terms of interest into the mapping database 110 using a user interface 102, and graphically maps the classes and term hierarchy using user interface 102. User interface 102 is also used to select some of the map entries, terms, and/or classes as the screening terms for determining which of the electronic documents needs analysis. A screening module 106B comprises processor instruction to automatically retrieve the mapping database 110 and automatically screen the electronic documents for the screening terms. Optionally, the subset of electronic documents that were found to contain the screening terms are automatically stored on NoSQL database 108. Optionally, all the electronic documents from document sources 120 are stored on NoSQL database 108 and the electronic documents that did not contain the screening terms are deleted from NoSQL database 108. Optionally, some documents are screened concurrently as other documents are being received.

The subset of electronic documents that passed the screening, may be automatically analyzed by hardware processor(s) 104 using the instructions of an analysis module 106C. For example, analysis module 106C comprises processor instructions to search for all terms and record the term unique codes and locations in the document. The positions of the terms may be automatically recorded, and compared. A semantic analysis of the word relationships and grammar may be automatically computed. A target function may compute an output value that represents the probability that the terms describe an event that needs to be recorded, and if the output value is above a threshold, a vector of unique codes, one for each class, is stored as a record in a SQL database 112.

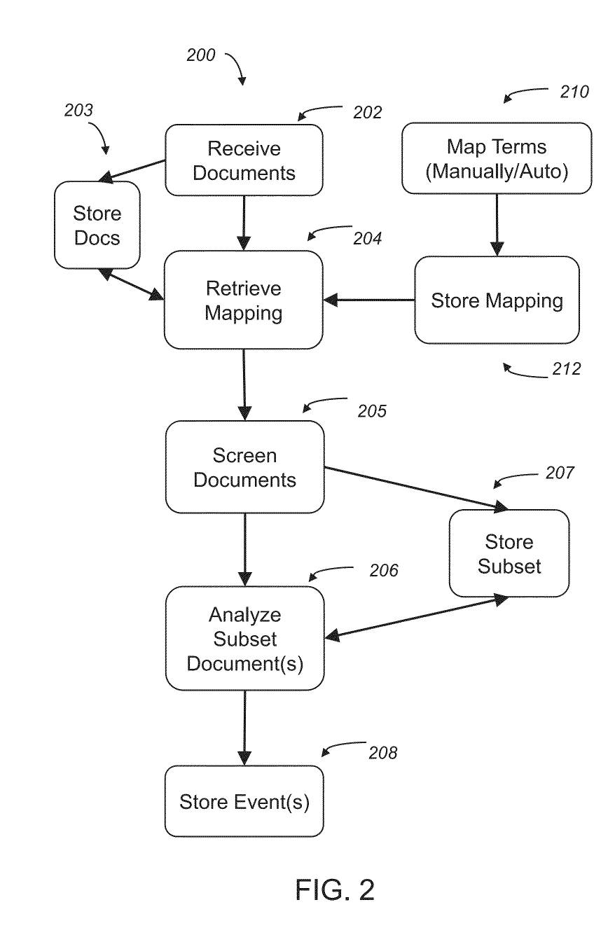

Reference is now made to FIG. 2, which is a flowchart of a method 200 for large database screening, according to some embodiments of the present invention. Method 200 comprises an action of receiving 202 electronic documents by hardware processor(s) 104, and optionally storing 203 the electronic documents in NoSQL database 108. Hardware processor(s) 104 retrieves 204 a previously stored 212 HMD, containing classes, map entries in each class, terms in each map entry, a hierarchy of terms, and a selection of screening terms.

A user may manually 210 enter using user interface 102 a map of map entries, terms, and classes that are stored 212 in the HMD. The HMD is used by hardware processor(s) 104 to screen 205 the electronic documents, thereby determining which subset of documents need to be further analyzed 206.

Analysis 206 of the subset of documents produces events when the analyzed terms meet one or more relationship criteria, and the events are stored 208 in SQL database 112. Optionally, the subset of electronic documents is stored 207 in SQL database 112 for reference, training, and/or the like. For example, a regular expression analysis, a semantic analysis, and/or the like is used to analyze an electronic document.

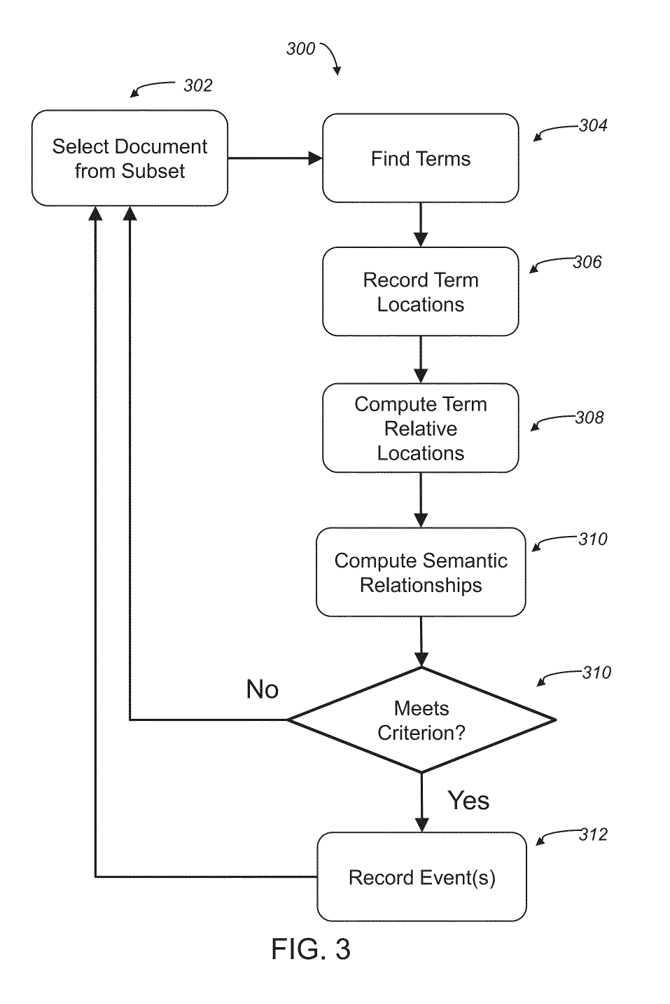

Reference is now made to FIG. 3, which is a flowchart of a method 300 for large database analysis after database screening, according to some embodiments of the present invention. Each electronic document in the subset is selected 302 for analysis by hardware processors(s) 104, and all terms in HMD 110 are found 304 in the document text. The term locations are recorded 306, and the relative term locations are computed 308. The semantic relationships between the terms are computed 310, including relations based on location, grammatical usage, relationship to other terms, and/or the like. When the terms and relationships meet 310 one or more criterion, the electronic document is flagged as containing relevant information and one or more events is recorded 312 as a vector of unique codes in database 112 based on this electronic document. The process then proceeds to the next electronic document until all electronic documents in the subset have been analyzed. As used herein, the term event means a vector of unique codes that record the details of each relevant event as determined by the analysis.

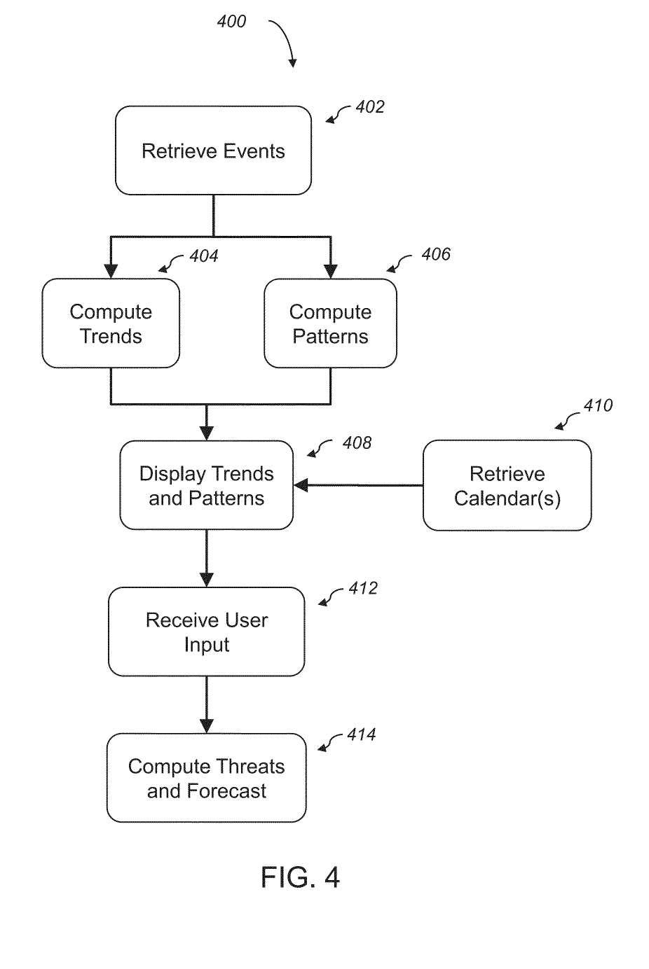

Reference is now made to FIG. 4, which is a flowchart of a method 400 for trend analysis, pattern analysis, and forecasting, according to some embodiments of the present invention. Once all electronic documents in the subset have been analyzed, the recorded 312 events are retrieved 402 from database 112, and hardware processor(s) 104 compute 404 trends and compute 406 patterns. For example, trends are computed using regression analysis. For example, patterns are computed using frequency analysis, machine learning, and/or the like. A calendar is retrieved 410, and the identified trends and patterns are displayed 408 to a user, such as a security analyst in security applications, an epidemiologist in medical applications, a police officer in missing person applications, and/or the like. The trends and patterns are overlaid on the calendar for visual analysis by a user for selection of noticeable patterns and trends. The user input is received 412 for selection of the patterns and trends that will be used to compute 414 a threat and/or forecast of a probability of a future event. For example, in medical applications a threat is a threat of a future epidemic of H1V1 flu virus. For example, in police applications a threat is a threat of a person, such as a serial killer, a child molester, or the like, committing a crime.

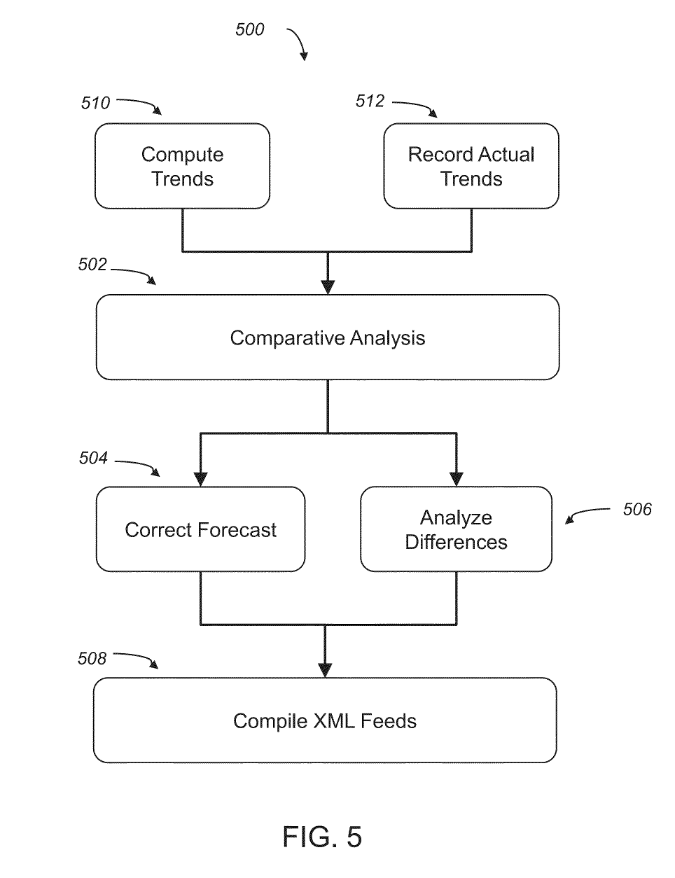

Reference is now made to FIG. 5, which is a flowchart of a method 500 for correcting a forecast with user input, according to some embodiments of the present invention. Hardware processor(s) 104 computes 510 trends of predicted events, and records 512 actual trends of events that have happened. A comparative analysis 502 between the predicted and actual trends can produce a corrected 504 forecast and analyzed 506 differences. These results may be compiled 508 to one or more Extensible Markup Language (XML) feeds.

Following are aspect of document sources 120 according to some embodiments.

Received 202 data may be collected from web sites, feeds, data providers, and/or the like. A variety of pre-defined qualified website sources may be browsed automatically and the electronic documents located thereon recorded. The electronic document sources may be of different types such as free text geopolitical articles, structured logs from clients, unstructured feeds from vendors, free text published case-studies, structured technical sniffer databases, third-party benchmark free text reports, free text event reports, JavaScript Object Notation (JSON) data, and/or the like. For example, JSON data is streamed to hardware processor(s) 104 from a document provider and the JSON data contains electronic documents. For example, in a security application embodiment the electronic document source is an open-source intelligence source, RSS feeds, Twitter accounts, blogs, websites, forums, Sixgill™ source, iSight document(s), and/or the like. Relevant data may be copied into a temporary work-in-progress database, such as a NoSQL database 108. For example, a MongoDB® database stores electronic documents using Binary JSON (BSON) format records.

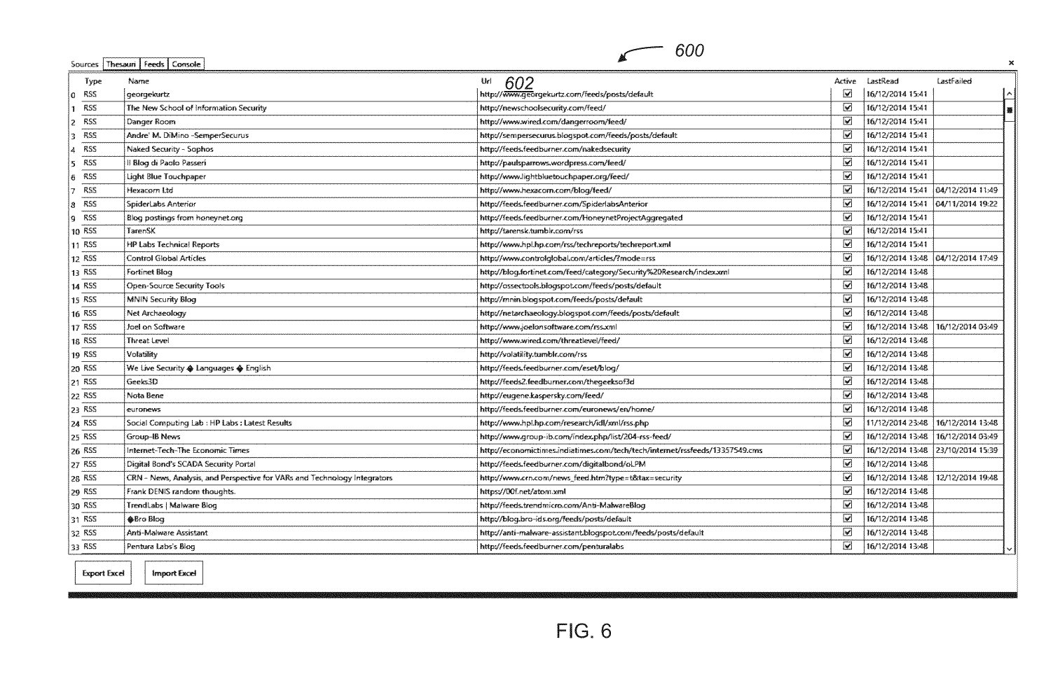

Reference is now made to FIG. 6, which shows a screenshot 600 of a list of such sources of an exemplary analysis system according to an embodiment. The list of sources may include a source type, a name, a URL, a uniform resource Identifier (URI) 602, a status, one or more date fields, and/or the like. As used herein , the term URL means any internet address capable of being converted to an electronic document, such as a URL, a URL, a feed, and/or the like.

The collecting mechanism may download only the relevant text from the different open-source intelligence sources, such as Rich Site Summary (RSS) feeds, Twitter accounts, forums, blogs, social media, and/or the like, into the database. This may be done on a daily basis or in any other desired frequency. For example, some sites are recorded on a daily basis and some sites are recorded on an hourly basis.

Electronic document may be recorded with items of interest, such as a headline, a tag line, a text body, one or more metadata, such as time-stamp, URL/URI, source name, and/or the like. Each item may be rated from most relevant for analysis to least relevant. The source URL may be stored in a SQL table. Hardware processor(s) 104 may execute periodically, such as every two hours, on demand, and/or the like, sets of processor instructions to retrieve electronic documents from the sources, such as a list of URLs, RSS feeds, Twitter feeds, XML feeds, and/or the like.

For example, internet web site feeds may be used to collect the RSS feeds. The hardware processor(s) 104 may receive the feed's title, summary and URL, then enter the URL address into a client browser and dump the text into a NoSQL database. For example, a tweeter feed may be collected by entering the link within the tweet and running the process of collecting the web site content.

In some embodiments, the electronic document collecting may be performed by using two different tools which complement each-other. For example, an open-source package, such as NReadability, may identify the main content in each RSS electronic document and dump the text into a database excluding photos, ads and irrelevant material. For example, an XML and/or HTML data parser, such as XPath, records electronic document sources. For example, a user interface may allow a user to select the relevant XPath for sources which the NReadability may be unable to analyze. In this example, XPath may allow following the relevant URL even if changes are made to the source. Using multiple collecting tools may allow automatic triggering of a second tool if the first tool, defined as the default tool, fails.

In case of a failure in the electronic document collecting, an appropriate notification may be issued to a user. The notification may indicate the problem and a proposed solution.

The collecting mechanism may run in a threading mode which may allow parallel execution of the different functions. This may save time and improve the method operation.

Following are aspect of HMD 110 according to some embodiments.

Mapping data in HMD 110 may be manually provided, for example, by a user, and/or extracted automatically from electronic document sources, such as scraped data, browsed data, data feeds, and/or the like, related to the application. The mapping data may be aggregated in a database, an online repository, and/or the like. Search terms in HMD 110 may be defined and updated periodically. The definition and updating of the terms may be based on user research and manually entered using a user interface 102. The mapping database may include a multi-layered hierarchical structure of terms to be analyzed, such as in security applications the terms for attacker (TA), attack method, geopolitical region, industry, such as of the company where the attack took place, asset objective, timeframe, and/or the like. For example, such multi-layered definitions of the “Attacker” terms in the English language may include: “Attacker”→types of attackers→names of known attackers of each type. Optionally, terms in one language are translated into multiple languages.

A HMD may be initially defined and updated periodically. The hierarchical mapping database may be defined and updated based on the existing terms, such as when adding a new language to the mapping database, or new terms, such as new attacker names The hierarchical mapping database may include synonyms and translations to human and technical languages of terms in various hierarchic levels of the mapping database.

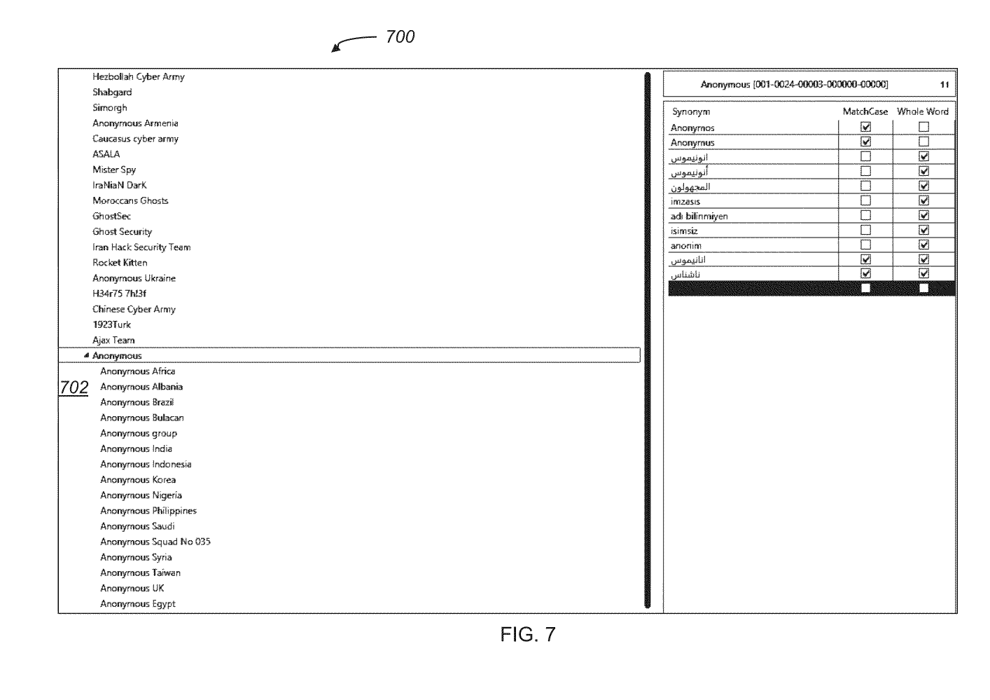

Reference is now made to FIG. 7, which is a screenshot 700 of a user interface showing a search result of the mapped entries “Anonymos” or “Anonymus” in a hierarchical mapping database, according to some embodiments of the present invention. The next level down in the hierarchy shows the different geographical groups 702 of the main group “Anonymous”.

The hierarchical mapping database may hold all the application relevant terms, such as TA, AM, GeoPol, industry, asset, objective, timeframe, and/or the like in security applications. The HMD also contains the term's hierarchies and synonyms, including in different languages. The hierarchical mapping database may be managed by a user, such as an intelligence analyst in security applications for example. The user may add elements, synonyms and adjust hierarchies on a regular basis and based on research results. Each term and synonym may have characteristics such as name, identification (ID), parent, case-sensitivity, such as to differentiate between it and IT, which represents the phrase Information Technology, whether the term is a whole word or part of a word, and/or the like.

The hierarchical mapping database may be saved in an SQL database (DB) table where each term may point to its parent term, thus forming a tree structure. Each term has a unique ID. During future changes in the hierarchical mapping database, the unique ID is not repeated, such as when a term is deleted, its ID is deleted with it only if there are no other terms linked to that unique ID. The synonyms for terms may be saved on a different table where each word may point to its parent in the main hierarchical mapping database. The term encoding may be, for example, in Unicode Transformation Format 8, which may allow the use of different languages and advanced search options.

The hierarchical mapping database may hold a black list of “noise” words which may be ignored during screening and may be omitted from analysis. For example, in security applications the entity “Anonymous OS”, which references an operating system used by several attackers may be omitted so the process will not tag the word “Anonymous” of “Anonymous OS” under TA.

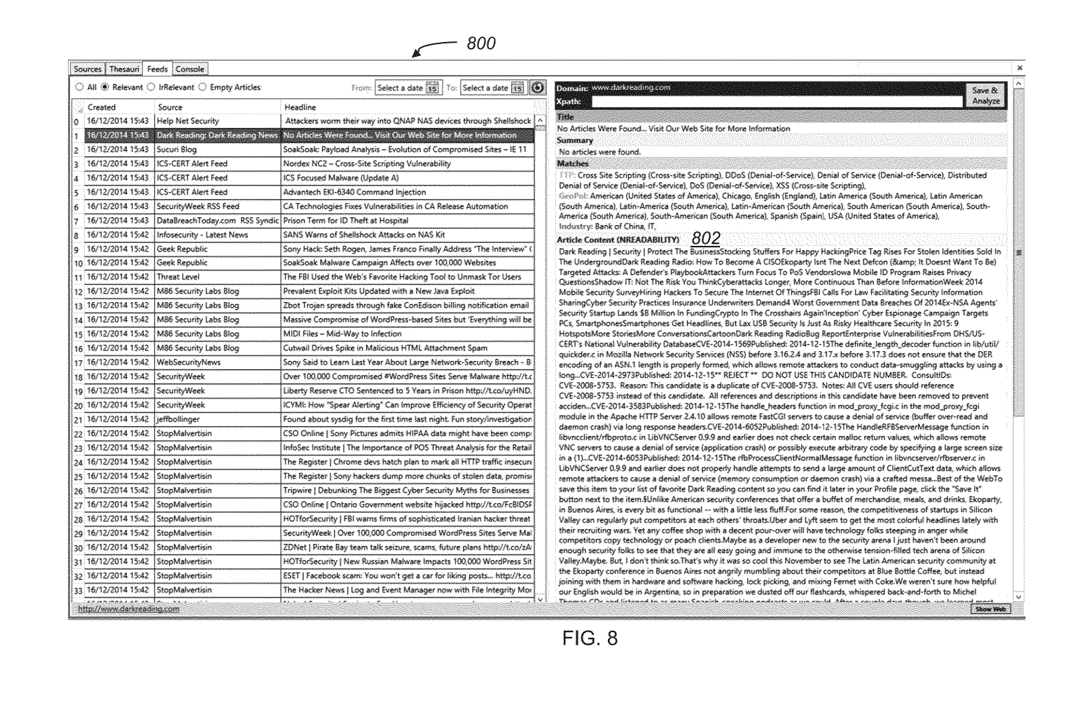

Optionally, a semantic analysis of terms within each electronic document may be performed. The hierarchical mapping database may be utilized to screen the collected electronic documents, such as articles, feeds, posts, and/or the like, into a subset of documents prior to analysis of each document into one or more coded event records. Once the text from all the sources is recorded in the database, a screening module may automatically screen the text of the electronic documents and search for hierarchical mapping database elements, including synonyms. The data may be then analyzed by converting each search term to a unique ID for each element. Each unique ID is determined according to the hierarchical mapping database, which converts multiple equivalent terms to a unique ID and class. Reference is now made to FIG. 8, which screenshot 800 of a user interface showing a subset list of electronic documents in a database after screening, according to some embodiments of the present invention. After screening, the electronic document is analyzed to determine 802 unique IDs for each term in the document.

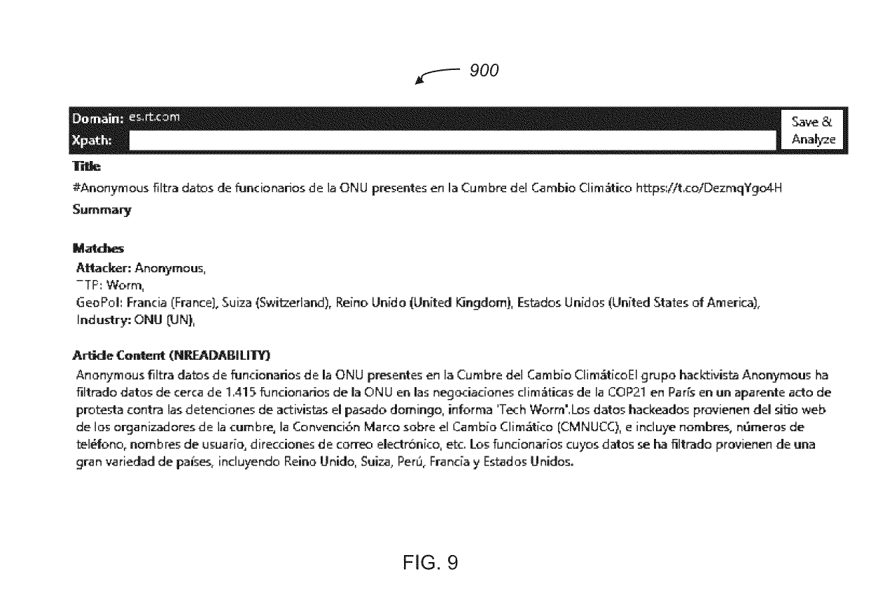

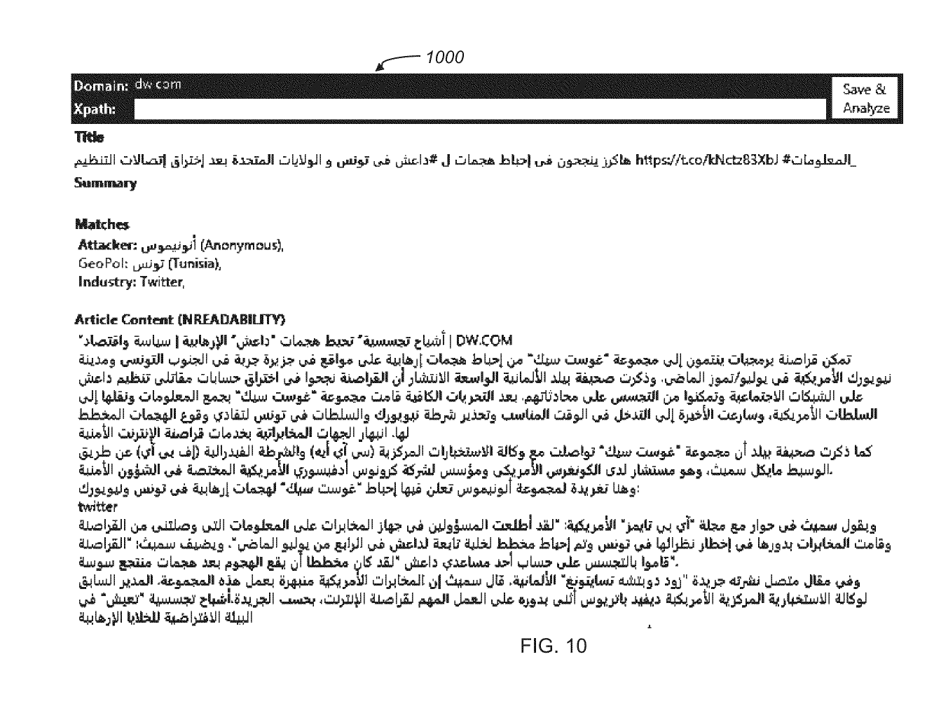

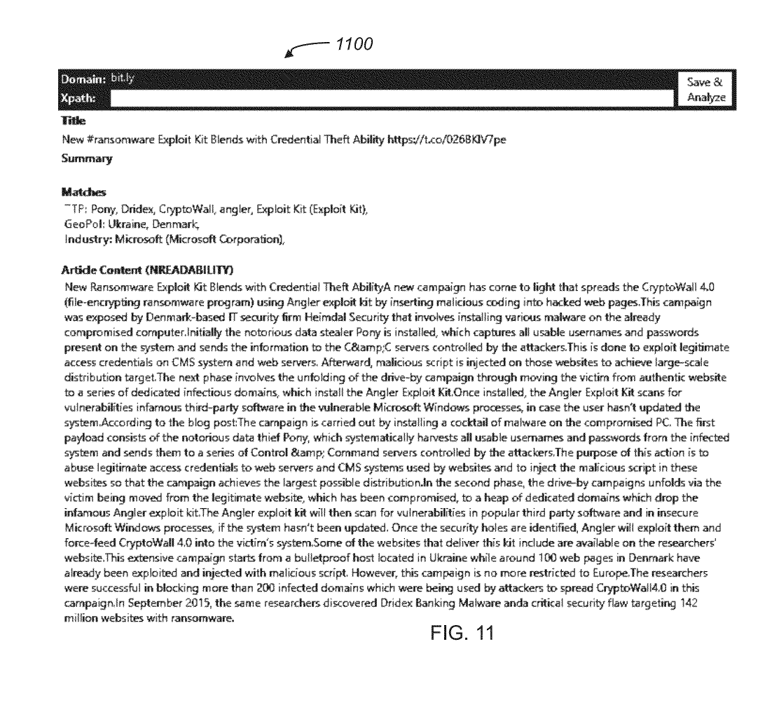

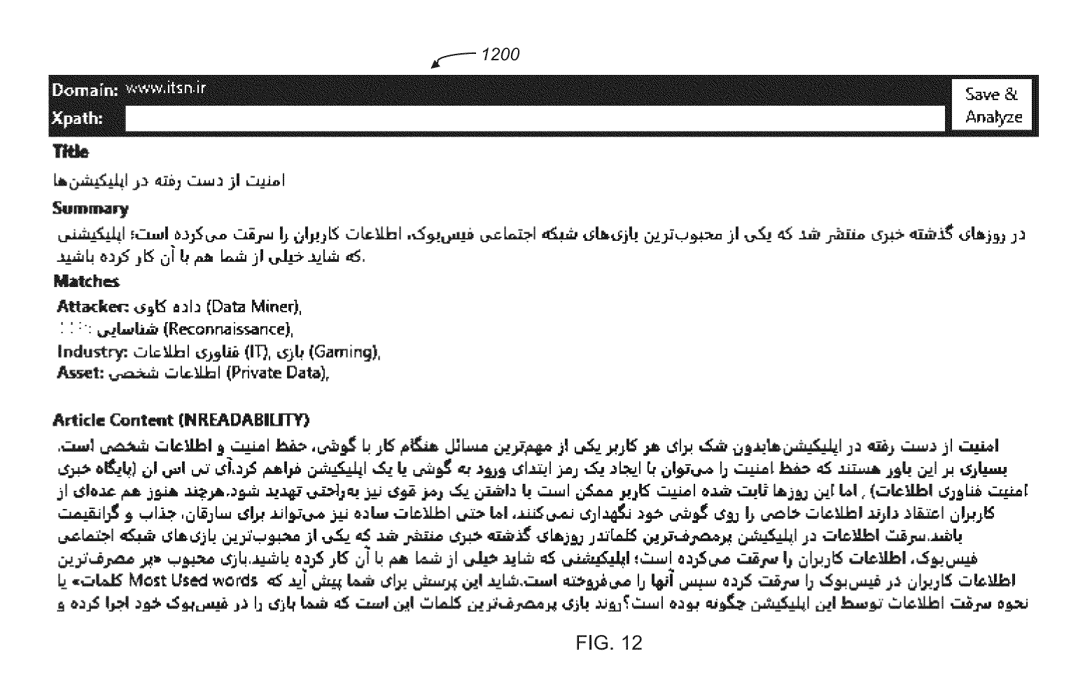

Optionally, event records can be detecting in electronic documents in multiple languages, allowing comparison of the vector of unique codes across the multiple languages. Reference is now made to FIG. 9, which is a screenshot 900 of an electronic document in the Spanish language and the resulting event record in a database, according to some embodiments of the present invention. Reference is now made to FIG. 10, which is a screenshot 1000 of an electronic document in the Arabic language and the resulting event record in a database, according to some embodiments of the present invention. Reference is now made to FIG. 11, which is a screenshot 1100 of an electronic document in the English language and the resulting event record in a database, according to some embodiments of the present invention. Reference is now made to FIG. 12, which is a screenshot 1200 of an electronic document in the Farsi language and the resulting event record in a database, according to some embodiments of the present invention.

For example, in a security application, collected electronic documents may be aggregated into time-stamped records of a NoSQL database 108. The electronic documents may be screened by locating both attacker and attack method terms anywhere within the electronic document, and adding this document to a subset for further analysis. When one or more of these are mentioned, a row in a SQL database may be generated and analyzed later by locating the relevant terms, such as attacker, attack method, GeoPol, Industry, and/or the like. By analyzing the location, relative location between terms, and semantic relationships, hardware processor(s) 104 may determine that one of several criterion is satisfied and an event record generated in an SQL database.

The search for the hierarchical mapping database terms in the text of each electronic document may be performed in a multi-threading mode to allow a fast and effective analysis. When the text is stored in the DB, retroactive tagging may be enabled after changes are made to the hierarchical mapping database. The search may be based on a regular expression, which may allow advanced search options, such as to define a word as a whole word, part of a word, a case sensitive word, and/or the like.

In order to prevent redundancy and errors, when a term is identified, it may be locked, tagged, and omitted from further analysis. For example, if the term “Anonymous Tunisia” is identified, it may be locked as a single element and the word “Tunisia”, which is a GeoPol element, may be prevented from being tagged separately.

In some embodiments, when an electronic document mentions one TA and several GeoPol's or Industries, several records in the event DB may be generated, for each GeoPol or Industry, with the same TA.

In some embodiments, when an electronic document mentions one TA, GeoPol or Industry, but several AM's, one record may be generated in the event DB, including several AM's in the AM column The AM's may be separated by a sign, “###” for example, so as not to cause problems in further analysis.

In some embodiments, when an electronic document mentions an AM but not a TA, a row in the event DB may including a unique ID designating “Unknown” in the TA column of an event record unique code vector.

When the event DB is generated, the system may tag in each source term the closest term to the leaves of the tree structure in the mapping database hierarchy it recognizes. For example, when in an electronic document the terms “Attacker” and a specific name of an attacker are mentioned, the specific name will be tagged and not the general term “Attacker”, which is higher in this term hierarchy. Thus, the entire flow of each element may be tagged, from the most general term, such as the top parent term, to the most refined term, providing more precise and flexible results for the purpose of analysis. The unique ID may be tagged to better the trends analysis.

Following are aspect of analyzing 206 a subset of electronic documents according to some embodiments.

The frequency of terms, such as attacker or attack method, may be measured based on the database entries. The frequency measurement of attacker or attack method events may be performed according to geopolitical region and/or industry. A dedicated table in the event DB may be generated automatically including the aggregated data per element frequency.

Periodic frequencies, such as daily and weekly frequencies, of elements per geopolitical region and/or industry, may be cumulated by determined periodic analysis. For example, a correlation analysis may be generated, including relevant correlations to be used in further analysis. The correlations may be generated for each set of GeoPol*Industry*AM and GeoPol*Industry*TA.

The trend analysis may be performed by using time-series statistics to present changes in behavior of attackers and attack methods over time in geopolitical regions and industries. These changes may be presented, for example, graphically, e.g., by trend lines on a user interface. Forecasting may be performed based on one or more terms. For example, attacker activity and attack methods may be analyzed to forecast activity in the near future, such as up to a few months, based on current or expected events. The forecast may be calculated according to statistical methods, such as moving weighted average, linear regression, and/or the like.

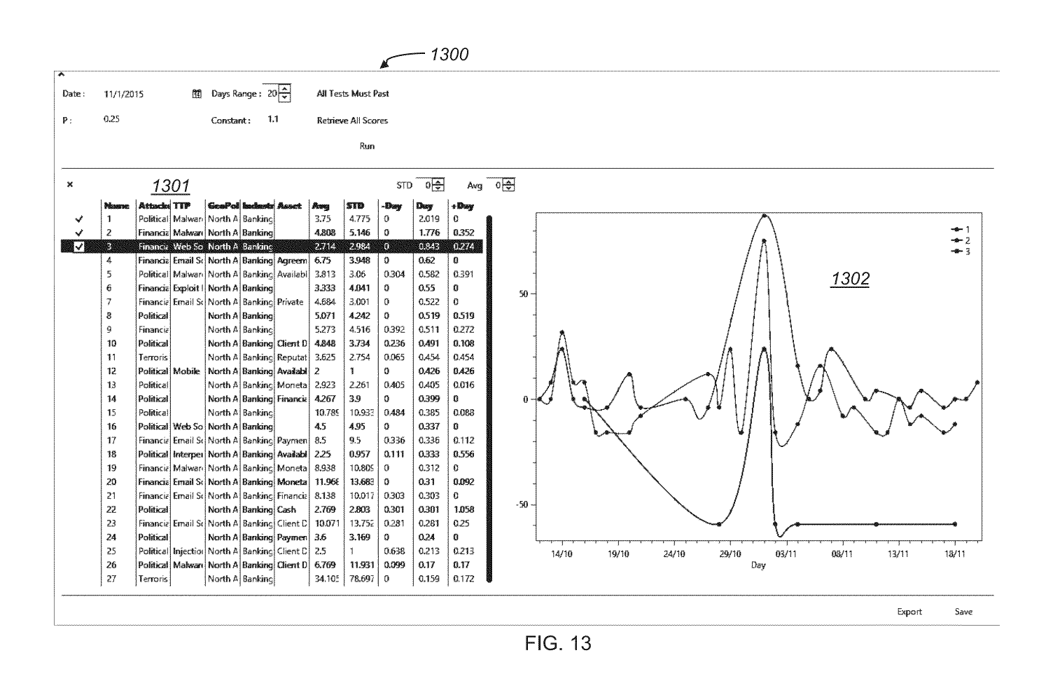

A calendar of event dates of different types, such as political, such as elections, economical, such as a G8 summit, technological, such as an iPhone announcement, military, such as an armed conflict initiation, declaration of war, and/or the like, may be generated. Calendars may include event dates and time frames. The event dates may be updated on a regular basis based on research. The research may be performed by using the above mentioned tools and/or external research may be used. Reference is now made to FIG. 13, which is a screenshot 1300 of analysis results of event records in a database displayed on a calendar, according to some embodiments of the present invention. Screenshot 1300 shows the cumulated evert records 1301 and trends analysis results 1302 on date axis.

Profiling of a calendar event dates may be performed. Behavior profiling of specific types of attackers, such as hacktivist, financial hacker, and/or the like, may be performed before, during and after a calendar event date of a certain type. The profiling may be performed based on the data stored in the event DB.

Once an event calendar is retrieved and/or generated, the calendar may be continuously updated manually and/or automatically. The calendar may be customizable and may allow the addition of ad-hoc types and event dates by a user. The calendar may be both global and/or geopolitically focused, to allow reference and benchmarking.

Calendar event date modifiers may be defined, such as coefficients. Each specific calendar event dates may have a time length modifier and an impact modifier. The impact modifiers may be coefficients applied to the frequencies of the terms in the electronic documents. The time length modifiers may be coefficients applied with respect to the time length of the calendar event dates, such as time before or after a date when the attack might take place. The modifiers may be defined based on the event type behavior profiles.

Pattern analysis with respect to the events may be performed. The pattern analysis may be performed based on the events behavior modifiers. In the building process of each event pattern, a timeline of modifiers on a periodic basis, such as weekly, may be built, based on previously observed trends and forecasts. Each event pattern may include a table with the different modifiers and/or a line graph on a user interface depicting the pattern visually, to improve research.

In some embodiments, terms relating to the same or similar events may be compared in order to enhance the pattern analysis.

Comparative analysis, such as forecasts, and analysis of the outcome of the events patterns, may be performed. This may be performed by correlating the forecasts and the events patterns. Linear and nonlinear correlations may be used, such as computing Pearson correlations, Spearman correlations, and/or the like. Data which is not correlated may be extracted for user review, which in turn may be updated in the relevant databases.

Corrected attackers and/or attack behavior forecasts may be generated based on the comparative analysis. Thus, correlated behavior may be compiled into forecasted behavior. The modifiers from the pattern analysis may be compared with the forecast data, to receive a corrected forecast according to patterns.

Optionally, the large database of electronic documents received from the sources is preserved in the NoSQL database, and a user may select a forecasted item, a trend, a pattern, and/or the like, on a user display, and select to view the analysis input data, the screened electronic documents, details of the original electronic documents with similar terms, and/or the like. In this manner the user can “drill down” from the high level analysis results to the original document data as needed to confirm or deny the analysis results. Optionally, the electronic documents are presented on a graphical user interface overlaid on a visual map of the internet showing the document source locations. For example, the locations are mapped as geographical locations, virtual locations, geopolitical locations, asset size locations, and/or the like. For example, the map is a distorted geopolitical map where the distortion is proportional to the value of an asset, the urgency of a threat, and/or the like.

A gap analysis of data values may be performed. The gaps between the corrected forecast and the data in the event DB may be analyzed and a gaps DB record may be generated. The gaps database may be divided into time windows. This may be performed to refine the outcomes of the forecast generated and the pattern analysis. This may also enable fool-proofing and further pattern recognition.

A compilation of the analysis results to XML Feeds may be performed for sending to other computerized systems, for storage in an online repository, and/or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the users computer, partly on the user's computer, as a stand-alone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. A method comprising using at least one hardware processor for:
receiving a plurality of electronic documents from a plurality of computerized sources, wherein each of said plurality of electronic documents comprise alphanumeric text;
retrieving, from a non-transitory storage medium, a hierarchical mapping database, wherein said hierarchical mapping database comprises records that map between:
(a) a plurality of map terms, each comprising a plurality of words, phrases, and codes, and
(b) a tree structure of unique codes, wherein said tree structure comprises unique codes for each of at least four classes, and wherein each of said plurality of map terms is mapped to one of said unique codes;
screening said plurality of electronic documents to obtain a subset of said plurality of electronic documents by locating in said plurality of electronic documents a matching between some of said map terms in some of said classes; and
storing said subset in a database on said non-transitory storage medium.

2. The method of claim 1, further comprising:
analyzing each electronic document of said subset to produce a plurality of target records, each target record comprising:
(i) a record vector of at least four values of said unique codes, and
(ii) a record hierarchy of said record vector values; and
storing said plurality of target records in a database on said non-transitory storage medium.

3. The method of claim 2, wherein said analyzing of each electronic document comprises:
locating all occurrences of said map terms in said electronic document;
calculating a positional relationship between said occurrences in said electronic document;
performing a sematic analysis of each of said occurrences to determine a sematic classification in said document and a sematic relationship between said occurrences; and
generating at least one database record for each instance of a detection of a plurality of said occurrences in a positional relationship according to one of a plurality of criteria, producing a plurality of target records for said subset;
wherein each said target record comprises at least one unique code for each of said classes, and wherein said at least four unique codes are selected to represent the unique codes closest to a leaf in said tree structure.

4. The method of claim 1, wherein said plurality of electronic documents is stored in a non-relational database.

5. The method of claim 1, wherein said subset is stored in a relational database.

6. The method of claim 1, wherein said screening performs a lossy compression of said plurality of electronic documents.

7. The method of claim 1, wherein each of said plurality of words, phrases, and codes are in at least one of a plurality of languages and a plurality of syntaxes.

8. A method comprising using at least one hardware processor for:
receiving a plurality of electronic documents stored on a non-relational NoSQL database, wherein each of said plurality of electronic documents comprise alphanumeric text;
retrieving, from a non-transitory storage medium, a hierarchical mapping database, wherein said hierarchical mapping database maps between:
(a) a plurality of map terms, each comprising one of a word, a phrase, and a code in a plurality of languages and a plurality of syntaxes, and
(b) a tree structure of unique codes, wherein said tree structure comprises unique codes for each of at least four classes, and wherein each of said plurality of map terms is mapped to one of said unique codes;
screening said plurality of electronic documents to obtain a subset of said plurality of electronic documents by locating in said plurality of electronic documents a matching between some of said map terms in some of said classes;
analyzing each screened electronic document in said subset by:
(i) locating all occurrences of said map terms within said screened electronic document,
(ii) calculating a positional relationship between said occurrences within said screened electronic document, and
(iii) generating at least one database record for each instance of a detection of a plurality of said occurrences in a positional relationship according to one of a plurality of criteria, producing a plurality of target records for said subset,
wherein each said database record comprises at least four of said unique codes, at least one unique code for each of said classes, and a plurality of hierarchal relationships, and wherein said at least four unique codes are selected to represent the unique codes closest to a leaf of said tree structure; and
storing said plurality of target records in a structured query language relational database located on said non-transitory storage medium.

9. A computerized system, comprising:
(a) a non-transitory computer-readable storage medium having stored thereon program code for:
receiving a plurality of electronic documents from a plurality of computerized sources, wherein each of said plurality of electronic documents comprise alphanumeric text;
retrieving a hierarchical mapping database, wherein said hierarchical mapping database comprises records that map between:
(i) a plurality of map terms, each comprising a plurality of words, phrases, and codes, and
(ii) a tree structure of unique codes, wherein said tree structure comprises unique codes for each of at least four classes, and wherein each of said plurality of map terms is mapped to one of said unique codes;
screening said plurality of electronic documents to obtain a subset of said plurality of electronic documents by locating in said plurality of electronic documents a matching between some of said map terms in some of said plurality of classes; and
storing said subset in a database; and
(b) at least one hardware processor configured to execute said program code.

10. The computerized system of claim 8, further comprising:
analyzing each electronic document of said subset to produce a plurality of target records, each target record comprising:
(1) a record vector of at least four values of said unique codes, and
(2) a record hierarchy of said record vector values; and
storing said plurality of target records in a database.

11. The computerized system of claim 9, wherein said plurality of electronic documents is stored in a non-relational database.

12. The computerized system of claim 9, wherein said subset is stored in a relational database.

13. The computerized system of claim 9, wherein said screening performs a lossy compression of said plurality of electronic documents.

14. The computerized system of claim 9, wherein each of said plurality of words, phrases, and codes are in at least one of a plurality of languages and a plurality of syntaxes.

15. A computer program product comprising a non-transitory computer-readable storage medium having program code embodied therewith, the program code executable by at least one hardware processor to:
receive a plurality of electronic documents from a plurality of computerized sources, wherein each of said plurality of electronic documents comprise alphanumeric text;
retrieve a hierarchical mapping database, wherein said hierarchical mapping database comprises records that map between:
(a) a plurality of map terms, each comprising a plurality of words, phrases, and codes, and
(b) a tree structure of unique codes, wherein said tree structure comprises unique codes for each of at least four classes, and wherein each of said plurality of map terms is mapped to one of said unique codes;
screen said plurality of electronic documents to obtain a subset of said plurality of electronic documents by locating in said plurality of electronic documents a matching between some of said map terms in some of said classes; and
store said subset in a database.

16. The computer program product of claim 15, wherein said program code further comprises processor instruction for:
analyzing each electronic document of said subset to produce a plurality of target records, each target record comprising:
(i) a record vector of at least four values of said unique codes, and
(ii) a record hierarchy of said record vector values; and
storing said plurality of target records in a database.

17. The computer program product of claim 15, wherein said plurality of electronic documents is stored in a non-relational database.

18. The computer program product of claim 15, wherein said subset is stored in a relational database.

19. The computer program product of claim 15, wherein said screening performs a lossy compression of said plurality of electronic documents.

20. The computer program product of claim 15, wherein each of said plurality of words, phrases, and codes are in at least one of a plurality of languages and a plurality of syntaxes.
